(19) United States
(12) Patent Application Publication
(10) Pub. No.: US 2019/0070995 A1
(43) Pub. Date: Mar. 7, 2019

(54) MOBILE TRAILER SYSTEMS FOR DEPLOYING UNMANNED AERIAL VEHICLES

(71) Applicant: Walmart Apollo, LLC, Bentonville, AR (US)

(72) Inventors: Robert L. Cantrell, Herndon, VA (US); Donald R. High, Noel, MO (US); Brian G. McHale, Chadderton Oldham (GB); Nicholas R. Antel, Springdale, AR (US); Gregory A. Hicks, Rogers, AR (US); Nathan G. Jones, Bentonville, AR (US); John J. O'Brien, Farmington, AR (US)

(21) Appl. No.: 16/117,389

(22) Filed: Aug. 30, 2018

Related U.S. Application Data
(60) Provisional application No. 62/553,310, filed on Sep. 1, 2017.

(51) Int. Cl. B60P 3/11; B60P 3/00; B64F 1/32; B64F 1/22; B64C 39/02; G06Q 50/28

(52) U.S. Cl. CPC B60P 3/11; B60P 3/007; B64F 1/32; B64C 2201/208; B64C 39/024; G06Q 50/28; B64C 2201/128; B64F 1/222

(57) ABSTRACT

In some embodiments, methods and systems are provided that for transporting and deploying unmanned aerial vehicles. The unmanned aerial vehicles may be deployed from mobile stations that include receptacles each configured to retain an unmanned aerial vehicle. The receptacles may be independently movable into relative positions that permit multiple unmanned aerial vehicles to be deployed simultaneously from the mobile stations.

### CROSS-REFERENCE TO RELATED APPLICATION

This application claims the benefit of U.S. Provisional Application No. 62/553,310, filed Sep. 1, 2017, which is incorporated herein by reference in its entirety.

### TECHNICAL FIELD

This disclosure relates generally to delivering products via unmanned aerial vehicles and, in particular, to mobile stations for deploying unmanned aerial vehicles.

### BACKGROUND

Product delivery using unmanned aerial vehicles (UAVs) is becoming a popular idea. The UAVs have limited flight range, since they are typically battery-powered. Some UAV-based delivery systems contemplate utilizing ground-based mobile (e.g., vehicle-mounted) UAV deployment stations, which can transport the UAVs from a product distribution center of a retailer to a geographic location proximal to the intended product delivery destinations to reduce the required flying time for the UAVs. However, if a conventional delivery truck were to carry one or more UAVs in the cargo area of the truck, not only would the cargo-carrying capacity of the delivery truck be reduced because of the space occupied by the UAVs, but the delivery truck driver would have to manually deploy the UAVs, which would be time consuming for the driver.

### BRIEF DESCRIPTION OF THE DRAWINGS

Disclosed herein are embodiments of systems, apparatuses, and methods for transporting and deploying UAVs. This description includes drawings, wherein:

FIG. 1 is a diagram of a system for transporting and deploying UAVs in accordance with some embodiments;

FIG. 2 is a diagrammatic side elevational view of a trailer housing including UAV-retaining receptacles that are in their stowed positions;

FIG. 3 is a diagrammatic side elevational view of a trailer housing including UAV-retaining receptacles that are in their deployed positions;

FIG. 4 is a diagrammatic top plan view of a trailer housing including UAV-retaining receptacles that are in their deployed positions;

FIG. 5 is a functional diagram of an exemplary computing device usable with the system of FIG. 1 in accordance with some embodiments;

FIG. 6 comprises a block diagram of a UAV as configured in accordance with some embodiments; and

FIG. 7 is a flow chart diagram of a process of for transporting and deploying UAVs in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, the systems, devices, and methods described herein relate to transporting and deploying UAVs via a mobile station including UAV-containing receptacles that are independently movable into relative positions that permit multiple UAVs to be deployed simultaneously from the mobile trailer.

In some embodiments, a trailer system for transporting and deploying unmanned aerial vehicles configured to transport one or more products to customers in one or more delivery destinations includes a trailer housing having an interior space and a plurality of receptacles each configured to retain at least one unmanned aerial vehicle. The receptacles are coupled to the housing such that each of the receptacles is permitted to independently move from a stowed position configured for storage of the at least one unmanned aerial vehicle to a deployed position configured for deployment of the at least one unmanned aerial vehicle. The receptacles are coupled to the housing such that at least two of the receptacles are permitted to be in the deployed position simultaneously, and such that at least two unmanned aerial vehicles are permitted to be deployed simultaneously from the at least two of receptacles that are in the deployed position.

In another embodiment, a method for transporting and deploying unmanned aerial vehicles configured to transport one or more products to customers in one or more delivery destinations includes: providing a trailer housing having an interior space; providing a plurality of receptacles each configured to retain at least one unmanned aerial vehicle; coupling the receptacles to the housing such that each of the receptacles is permitted to independently move from a stowed position configured for storage of the at least one unmanned aerial vehicle to a deployed position configured for deployment of the at least one unmanned aerial vehicle; and coupling the receptacles to the housing such that at least two of the receptacles are permitted to be in the deployed position simultaneously, and such that at least two unmanned aerial vehicles are permitted to be deployed simultaneously from the at least two of receptacles that are in the deployed position.

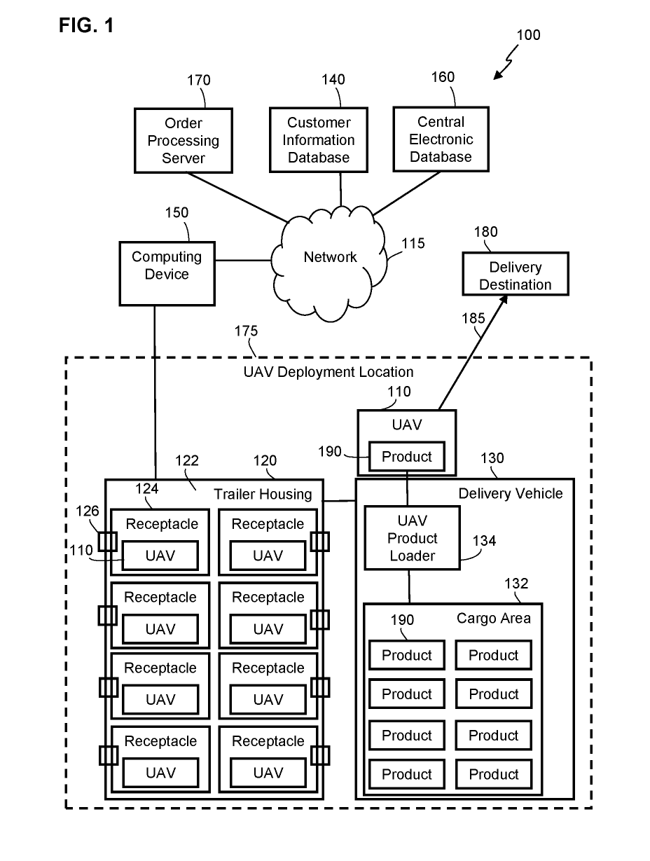

FIG. 1 shows an embodiment of a trailer system 100 for transporting and deploying unmanned aerial vehicles (UAVs) 110 configured to deliver one or more products 190 to customers in one or more delivery destinations 180. It will be understood that the details of this example are intended to serve in an illustrative capacity and are not necessarily intended to suggest any limitations in regards to the present teachings.

A customer may be an individual or business entity. A delivery destination 180 may be a home, work place, or another location designated by the customer when placing the order or scheduling a return pickup. Exemplary products 190 that may be ordered by the customer and delivered by the UAVs 110 via the system 100 may include, but are not limited to, general-purpose consumer goods (retail products and goods not for sale) and consumable products (e.g., food items, medications, or the like). A retailer may be any entity operating as a brick-and-mortar physical location and/or a website accessible, for example, via an intranet, internet, or another network, by way of which products 190 may be ordered by a consumer for delivery via a UAV 110.

The exemplary embodiment depicted in FIG. 1 is a trailer system 100 including a UAV Trailer (hereinafter referred to as a “trailer housing”) 120 having an interior space 122 configured to retain a plurality of UAVs 110. The system 100 also includes a delivery vehicle 130 coupled to the trailer housing 120. In some embodiments, the delivery vehicle 130 is a manned or unmanned transport vehicle (e.g., conventional delivery truck, autonomous ground vehicle, etc.) configured to haul the trailer housing 120 and thereby facilitate the movement of the trailer housing 120 to/from the UAV deployment location 175, such that the trailer housing 120 is mobile, and is intended to move between various UAV deployment locations via the delivery vehicle 130.

While in the exemplary system 100, the trailer housing 120 is coupled to a delivery vehicle 130, it will be appreciated that, in some embodiments, the trailer housing 120 may be configured in the form of a stand-alone vehicle (manned or unmanned) that does not depend on the delivery vehicle 130 for movement from/to the UAV deployment location 175. In other embodiments, the trailer housing 120 may be stationary and is not intended to move (e.g., installed at a sales facility of a retailer, distribution center of a retailer, or any other facility).

In the embodiment shown in FIG. 1, the UAVs 110 stored in the receptacles 124 of the trailer housing 120 are not loaded with products 190, and the products 190 are stored in the cargo area 132 of the delivery vehicle 130, which is equipped with a UAV product loader 134 configured to load the products 190 stored in the cargo area 132 into the UAVs 110. In some aspects, the product loader 134 is configured to pick a product 190 from the cargo area 132 of the delivery vehicle 130 and to load the picked product 190 into a UAV 110 that has landed on top of the delivery vehicle 130 as shown in FIG. 1, where a feeder/output device of the product loader 134 is configured to load the product picked by the product loader 134 into the UAV 110. In some aspects, the delivery vehicle 130 includes one or more guiding lights and/or lasers that may be detected by the sensors of the UAV 110 such that the UAV 110 is able to precisely land on top of the feeder/output device of the product loader 134. The UAV product loader 134 may include but is not limited to a conveyor belt, picking arm, chute, or the like. It will be appreciated that the product loader 134 is being shown as being operatively coupled to a UAV 110 located on top of the delivery vehicle 130 by way of example only, and that the product loader 134 may be configured to pick and load products 190 into the UAV 110 when the UAV 110 is located within the cargo area 132 of the delivery vehicle 130, adjacent the delivery vehicle 130, or when the UAV 110 is located within its receptacle 124 in the trailer housing 120.

While FIG. 1 shows that the UAVs 110 stored in the receptacles 124 of the trailer housing 120 are not loaded with products 190, it will be appreciated that in some implementations, products 190 may be manually (by a worker) or automatically (via a conveyor) be loaded into the UAVs 110 (e.g., at a product distribution center of a retailer) prior to the UAVs 110 being loaded into the receptacles 124 of the trailer housing 120. In addition, while in the exemplary embodiment of FIG. 1, the products 190 are stored in the cargo area 132 of the delivery vehicle 130, in some embodiments, the trailer housing 120 is configured to have a product storage area (akin to the cargo area 132 of the delivery vehicle 130) within the interior space 122 of the trailer housing 120. In such embodiments, the product storage area of the trailer housing 120 stores the products 190 before the products 190 are loaded into the UAVs 110 retained in the receptacles 124, and the interior space 122 includes a product loading device (akin to the UAV product loader 134 of FIG. 1) configured to pick one or more of the products 190 from the product storage area of the trailer housing 120, and to load the picked products 190 into the UAVs 110 prior to deployment of the UAVs 110 from the trailer housing 120.

The interior space 122 of the trailer housing 120 includes receptacles 124 that are each configured to retain one or more UAVs 110. In some aspects, the UAVs are configured to transport, via one or more flight routes 185, one or more products 190 from the UAV deployment location 175 to one or more delivery destinations 180 designated by a customer when placing an order for the products 190. In other aspects, the UAVs 110 are configured to return from their respective delivery destinations 180 to the trailer housing 120 along one or more flight routes 185.

In some embodiments, the trailer housing 120 and the receptacles 124 each have an open air design, being formed, for example, by a mesh (e.g., metallic, polymer etc.) material configured to provide a rigid structure that permits the trailer housing 120 to be hauled by the delivery vehicle 130 along various types of roads/terrains, and that permits ambient air to flow into the interior space 122 of the trailer housing 120 through the openings in the mesh material, thereby facilitating the take-offs and landings of the propeller-based UAVs 110. In some embodiments, the trailer housing 120 includes a wireless hotspot and/or wireless signal amplifier to facilitate the communication of the computing device 150 with the UAVs 110 controlled by the computing device 150. In some implementations, the trailer housing 120 may include a charging source configured to charge UAVs 110 remotely, without requiring the UAVs 110 to land into the receptacles 124.

While the trailer housing 120 is shown in the exemplary embodiment of FIG. 1 as retaining eight UAV-containing receptacles 124 and eight UAVs 110, it will be appreciated that in some embodiments, the trailer housing 120 may include a different number of UAVs 110, for example, 4, 6, 10, 12 16, or more. In some aspects, the trailer housing 120 is configured to expand in length and/or width (e.g., via a telescopic, hydraulic, rail, or the like mechanism) in order to increase the interior space 122 of the trailer housing 120 and permit the trailer housing 120 to retain more (e.g., 16) receptacles 124 than shown in FIG. 1. In addition, while the exemplary UAV-containing receptacles 124 shown in FIG. 1 each contain one UAV 110, it will be appreciated that in some embodiments, each receptacle 124 may retain more than one (e.g., 2, 3, 4, or more) UAV 110. In one aspect, each receptacle 124 includes a sensor configured to detect the presence of a UAV 110 therein, and to communicate such sensor data to a computing device 150, which will be described in more detail below, and which controls deployment of the UAVs 110 from the receptacles 124. Such UAV-detecting sensors enable the computing device 150 to recognize how many UAVs 110 are retained in the trailer housing 120 at any given time.

In certain embodiments, each receptacle 124 includes one or more lights (e.g., lasers) and/or guidance inputs recognizable by the sensors of the UAVs 110 when the UAVs 110 are located in the vicinity of the receptacle 124 (e.g., when attempting to land onto/into the receptacle 124 and/or when lifting off from the receptacle 124). For example, when the receptacle 124 is in a deployed position, the UAV 110 may descend from above into the receptacle 124 while being guided by such lights and/or guidance inputs of the receptacle 124. In some aspects, the receptacle 124 does not have to be in the deployed position for the UAV 110 to be able to land into the receptacle 124. For example, in certain implementations, the trailer housing is configured to include one or more retractable arms configured to grasp and/or scoop a UAV 110 that has landed on the ground adjacent to or below the trailer housing 120 (or that has landed on top of the trailer housing 120), and to retract the UAV 110 into the interior space 122 of the trailer housing 120, after which, the retractable arm can either load the UAV 110 into its respective receptacle 124, or place the UAV 110 onto a conveyor belt that is configured to move the UAV 110 within the interior space 122 of the trailer housing 120 and to load the UAV 110 into its respective receptacle 124. In some embodiments, instead of being scooped up into the interior space 122 of the trailer housing 120, the UAV 110 lands into the cargo area 132 of the delivery vehicle 130, and is transported into the trailer housing 120 via a conveyor belt that interconnects the cargo area 132 of the delivery vehicle 130 and the interior space 122 of the trailer housing 120. In one aspect, the UAV 110 is configured to land directly onto such an interconnecting conveyor (when the conveyor is stopped and/or when the conveyor is moving).

In one aspect, each receptacle 124 includes a charging mechanism configured to directly (e.g., a dock) or indirectly (e.g., induction) charge the battery of the UAV 110 located in the receptacle 124. In another aspect, the charging mechanism is not located within the receptacle 124, but is located adjacent the receptacle 124 such that a UAV 110 located in the receptacle 124 may be charged by such a charging mechanism either directly (e.g., dock, cable, etc.) or indirectly (e.g., induction, etc.). In some embodiments, the receptacle 124 may also include one or more coupling structures configured to permit the UAV 110 to detachably couple to the receptacle 124 during and/or after landing on the support surface of the receptacle, which advantageously secures the UAV 110 and restricts the UAV 110 from bouncing around when the trailer housing 120 is being towed by the delivery vehicle 130 (e.g., to the UAV deployment location 175). It will be appreciated that the relative sizes and proportions of the receptacle 124, UAV 110, products 190, trailer housing 120, and delivery vehicle 130 in FIG. 1 are exemplary and are not drawn to scale.

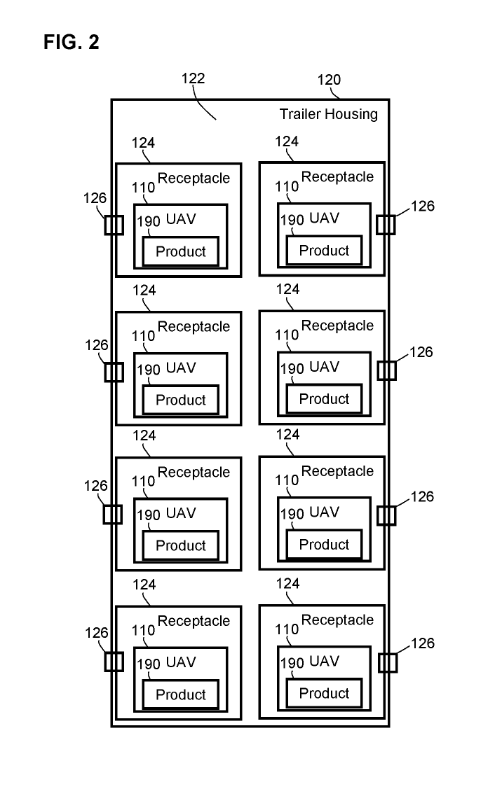

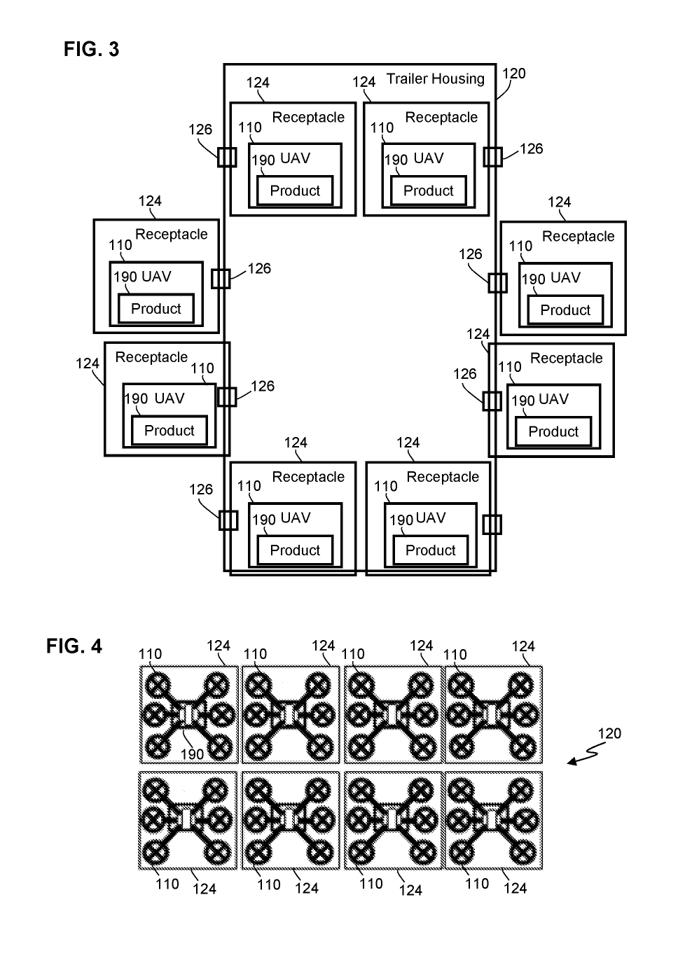

In some embodiments, the receptacles 124 are trays, drawers, or combinations or trays and drawers. In the embodiment illustrated in FIG. 1, the receptacles 174 are coupled to the trailer housing 120 and/or to each other in a stacked orientation such that the UAVs 110 (other than those in the bottom-most receptacles 124) retained in such receptacles 124 are stacked on top of one or more other UAVs 110. In the embodiment illustrated in FIG. 1, the receptacles 124 of the trailer housing 120 are coupled to the trailer housing 120 such that each of the receptacles 124 is permitted to independently move from a stowed position (see FIG. 2) configured for storage of the UAVs 110 to a deployed position (see FIG. 3) configured for deployment of the UAVs 110. In some embodiments, the receptacles 124 are configured as lockers for storing products 190 and accessible by an access code, such that the driver of the delivery vehicle 130 (or a driver of a separate delivery service) can access the products 190 contained in a given receptacle 124 for a delivery of such products 190 to a delivery destination without using a UAV 110.

In some implementations, one or more of the receptacles 124 are movably coupled to the trailer housing 120 via one or more movable connectors 126 (e.g., pivots, hinges, swivels rails or the like) that permit such receptacles 124 to swing, slide, or otherwise move from the stowed position of FIG. 2 to the deployed position of FIG. 3. In certain embodiments, of the receptacles 124 may be fixedly coupled to the trailer housing 120 so that such receptacles 124 do not move from a stowed position to a deployed position, but are instead permitted to deploy the UAVs 110 stored therein due to movement of other receptacles 124 from their stowed position (in which the movable receptacles 124 obstruct deployment of the UAVs 110 from the stationary receptacles 124) to their deployed position (in which the movable receptacles 124 no longer obstruct deployment of the UAVs 110 from the stationary receptacles 124).

In some embodiments, the movable connectors 126 are configured to cause movement of the receptacles 124 from their stowed position to their deployed position (and vice versa) in response to receiving a control signal from the computing device 150. For example, the movable connector 126 may include a transceiver configured to wirelessly receive control signals from the computing device 150 over the network 115 and operatively coupled to an electric motor or another device that, when activated, causes the receptacles to pivot, slide, or otherwise move between the stowed and the deployed positions.

In the illustrated embodiment, the receptacles 124 are coupled to the trailer housing 120 such that two or more of the receptacles are permitted to be in the deployed position simultaneously, as shown, for example, in FIG. 3. In particular, as shown in FIGS. 3 and 4, the trailer housing 120 is configured such that when the receptacles 124 are moved via their respective movable connectors 126 to the deployed position, no receptacle 124 that is in the deployed position overlays another receptacle 124 that is in the deployed position. In one exemplary configuration as shown in FIG. 3, all receptacles 124 are in the deployed position relative to FIG. 2 after the two top-most receptacles 124 remain stationary, the two receptacles 124 right below them slide out of the sides of the trailer housing 120, the two receptacles 124 located right below those pivot to a corner of the trailer housing 120, and the two bottom-most receptacles slide out of the rear of the trailer housing 120. It will be appreciated that various other configurations may be employed to achieve a position, where all eight of the receptacles 124 are deployed and do not overlay any other receptacles 124, and are not overlaid by any other receptacles 124. In other words, when a receptacle 124 of the trailer housing 120 is in the deployed position and ready to deploy one or more UAVs 110 therefrom, this receptacle 124 does not overlay and is not overlaid by any other deployed receptacles 124 and thus does not obstruct deployment of UAVs 110 from such other deployed receptacles 124 and is itself not obstructed by any of the other deployed receptacles 124. As a result, the trailer housing 120 is configured to permit two or more (e.g., 4, 6, 8, 10, 16, etc.) UAVs 110 to be deployed simultaneously from two or more of the receptacles 124 when the receptacles 124 are in the deployed position.

The exemplary system 100 depicted in FIG. 1 includes an order processing server 170 configured to process a purchase order by a customer for one or more products 190. It will be appreciated that the order processing server 170 is an optional component of the system 100, and that some embodiments of the system 100 are implemented without incorporating the order processing server 170. The order processing server 170 may be implemented as one server at one location, or as multiple interconnected servers stored at multiple locations operated by the retailer, or for the retailer. As described in more detail below, the order processing server 170 may communicate with one or more electronic devices of system 100 via a network 115. The network 115 may be a wide-area network (WAN), a local area network (LAN), a personal area network (PAN), a wireless local area network (WLAN), Wi-Fi, ZigBee, Bluetooth, or any other internet or intranet network, or combinations of such networks. Generally, communication between various electronic devices of system 100 may take place over hard-wired, cellular, Wi-Fi or Bluetooth networked components or the like. In some embodiments, one or more electronic devices of system 100 may include cloud-based features, such as cloud-based memory storage.

In the embodiment of FIG. 1, the order processing server 170 communicates with a customer information database 140. In some embodiments, the customer information database 140 may be configured to store information associated with customers of the retailer who order products 190 from the retailer. In some embodiments, the customer information database 140 may store electronic information including but not limited to: personal information of the customers, including payment method information, billing address, previous delivery addresses, phone number, product order history, pending order status, product order options, as well as product delivery options (e.g., delivery by UAV) of the customer. The customer information database 140 may be stored, for example, on non-volatile storage media (e.g., a hard drive, flash drive, or removable optical disk) internal or external to the order processing server 170, or internal or external to computing devices separate and distinct from the order processing server 170. It will be appreciated that the customer information database 140 may likewise be cloud-based.

In the embodiment of FIG. 1, the order processing server 170 is in communication with a central electronic database 160 configured to store information associated with the inventory of products 190 made available by the retailer to the customer, as well as information associated with the UAVs 110 utilized by the system 100 to deliver products 190 to the delivery destinations 180 specified by the customers. In some aspects, the central electronic database 160 stores information including but not limited to: information associated with the products 190 being transported by the UAVs 110 and/or delivery vehicles 130; inventory (e.g., on-hand, sold, replenishment, etc.) information associated with the products 190; information associated with predetermined flight routes 185 of the UAVs 110; UAV status input information detected by one or more sensors of the UAVs 110 during flight along their flight routes 185; coordinates of the UAV deployment location 175 and/or delivery destination 180, etc. In some embodiments, UAV status input information may include but is not limited to: battery status of the UAV 110, predicted flight range of the UAV 110 until all battery power is depleted, flight status/mission status of the UAV 110; and global positioning system (GPS) coordinates of the UAV 110.

The central electronic database 160 may be stored, for example, on non-volatile storage media (e.g., a hard drive, flash drive, or removable optical disk) internal or external to the order processing server 170, or internal or external to computing devices separate and distinct from the order processing server 170. The central electronic database 160 may likewise be cloud-based. While the customer information database 140 and the central electronic database 160 are shown in FIG. 1 as two separate databases, it will be appreciated that the customer information database 140 and the central electronic database 160 can be incorporated into one database.

With reference to FIG. 1, the computing device 150 may be a stationary or portable electronic device, for example, a desktop computer, a laptop computer, a tablet, a mobile phone, or any other electronic device including a processor-based control circuit (i.e., control unit). In this specification, the term “computing device” will be understood to refer to a computing device owned by the retailer or any computing device owned and/or operated by an entity (e.g., delivery service) having an obligation to deliver products 190 for the retailer. The computing device 150 of FIG. 1 is configured for data entry and processing as well as for communication with other devices of system 100 via the network 115. In some embodiments, as will be described below, the computing device 150 is configured to communicate with the central electronic database 160 and/or customer information database 140 and/or UAVs 110 and/or hand-held device of a driver of the delivery vehicle 130 via the network 115 to facilitate deployment of UAVs 110 from the trailer housing 120 and the delivery of products 190 via UAVs 110 along flight routes 185 to delivery destinations 180. In some aspects, the computing device 150 is configured to guide the delivery vehicle 130 to the UAV deployment location 175, to facilitate deployment of the UAVs 110 from the trailer housing 120, and as to guide the UAVs 110 from the UAV deployment location 175 to their respective delivery destinations 180.

Notably, while FIG. 1 shows the computing device 150 as a stand-alone device, in some embodiments, the computing device 150 is incorporated into the trailer housing 120 (and may be operated by the driver of the delivery vehicle 130). In such configurations, the trailer housing 120 does not depend on control signals from a remote central computing device, which both reduces the processing requirements of centralized computer devices of the retailer, and ensures reliable communication between the computing device 150 and the UAVs 110, since the computing device 150 and the UAVs are all contained in the trailer housing 120. In other embodiments, the computing device 150 may be incorporated into the delivery vehicle 130 (and may be operated by the driver of the delivery vehicle 130). In yet other embodiments, the computing device 150 is a central computer that communicates with and controls UAVs 110 located in various different trailer housings 120 in different geographic locations. While the order processing server 170 and the customer information database 140 and the central electronic database 160 are shown in FIG. 1 as being separate and distinct from the computing device 150, it will be appreciated that the customer information database 140 and/or the central electronic database 160 and/or the order processing server 170 can be incorporated into the computing device 150 in some embodiments.

In the system 100 shown in FIG. 1, the computing device 150 is in two-way communication with the UAVs 110 via the network 115. In some aspects, the computing device 150 is configured to transmit at least one signal to the UAVs 110 to cause the UAVs 110 to deploy from their respective receptacles 124 and to fly along a flight route 185 determined by the computing device 150 while transporting products 190 from the UAV deployment location 175 to the intended delivery destination 180 (e.g., to drop off a product 190 or to pick up a product 190), or while returning from the delivery destination 180 to the UAV deployment location 175 (e.g., after dropping off a product 190 or after picking up a product 190). In other aspects, after a customer places an on order for one or more products 190 and specifies a delivery destination 180 for the products 190 via the order processing server 170, prior to and/or after the commencement of a delivery attempt of the products 190 ordered by the customer via a UAV 110 to the delivery destination 180, the computing device 150 is configured to obtain GPS coordinates associated with the delivery destination 180 selected by the customer and GPS coordinates associated with the UAV deployment location 175, and to determine flight routes 185 for the UAVs 110 from the UAV deployment location 175 to their respective delivery destinations 180.

A UAV 110 as shown in FIG. 1, which will be discussed in more detail below with reference to FIG. 3, is generally an unmanned aerial vehicle configured to autonomously traverse one or more intended environments in accordance with one or more flight routes 185 determined by the computing device 150, and typically without the intervention of a human or a remote computing device, while retaining the products 190 therein and delivering the products 190 from the UAV deployment location 175 to the delivery destination 180. In some instances, however, a remote operator or a remote computer may temporarily or permanently take over operation of the UAV 110 using feedback information (e.g., audio and/or video content, sensor information, etc.) communicated from the UAV 110 to the remote operator or computer via the network 115, or another similar distributed network. While only eight UAVs 110 are shown in FIG. 1 for ease of illustration, it will be appreciated that in some embodiments, the computing device 150 may communicate with, and/or provide flight route instructions to more than eight (e.g., 16, 20, or more) UAVs 110 simultaneously to facilitate take-offs/landings of the UAVs 110 from/onto the trailer housing 120, to guide the UAVs 110 from their respective UAV deployment locations 175 while transporting products 190 to their respective delivery destinations 180, and/or to facilitate landings/take-offs of the UAVs 110 at the delivery destinations 180. Notably, as described above, in some embodiments, the computing device 150 is not specific to the UAVs 110 retained in the trailer housing 120, and may be a central computing device configured to control over the network 115 hundreds or even thousands of UAVs retained in dozens or hundreds of trailer housings 120 in various geographic locations.

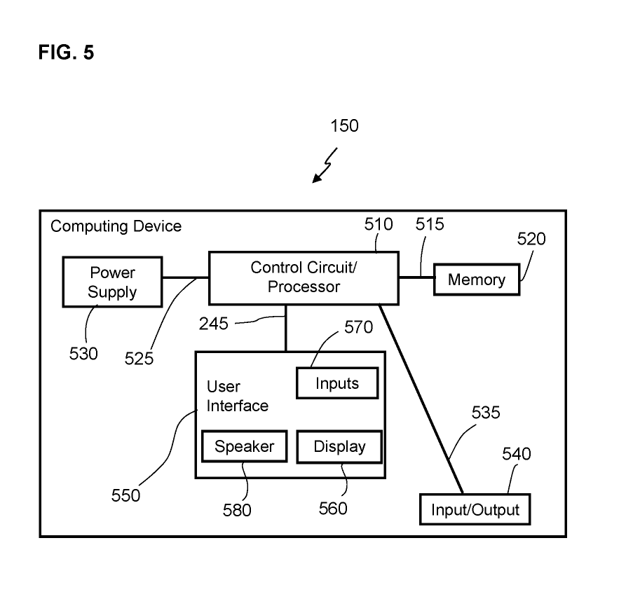

With reference to FIG. 5, an exemplary computing device 150 configured for use with the systems and methods described herein may include a control unit or control circuit 510 including a processor (for example, a microprocessor or a microcontroller) electrically coupled via a connection 515 to a memory 520 and via a connection 525 to a power supply 530. The control circuit 510 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 510 of the computing device 150 can be configured (for example, by using corresponding programming stored in the memory 520 as will be well understood by those skilled in the art) to carry out one or more of the steps, actions, and/or functions described herein. In some embodiments, the memory 520 may be integral to the processor-based control circuit 510 or can be physically discrete (in whole or in part) from the control circuit 510 and is configured non-transitorily store the computer instructions that, when executed by the control circuit 510, cause the control circuit 510 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Thus, the memory and/or the control circuit may be referred to as a non-transitory medium or non-transitory computer readable medium.

The control unit 510 of the computing device 150 is also electrically coupled via a connection 535 to an input/output 540 that can receive signals from the order processing server 170 (e.g., data from the customer information database 140 relating to an order for a product 190 placed by customer 105 and/or information (e.g., GPS coordinates) associated with a physical location of the UAV deployment location 175 and/or UAV 110 and/or delivery destination 180), or from any other source that can communicate with the computing device 150 via a wired or wireless connection over the network 115. The input/output 540 of the computing device 150 can also send signals to the order processing server 170 (e.g., electronic notification confirming delivery of a product by a UAV 110 to a delivery destination 180), as well as to the UAV 110 (e.g., instruction to deploy from the receptacle 124 and/or to land on/couple to the delivery vehicle 130 for a product 190 to be loaded into the UAV 110 and/or route instructions to guide the UAV 110 from the UAV deployment location 175 to the delivery destination 180, etc.), or to any other device in wired or wireless communication with the computing device 150.

In the embodiment of FIG. 5, the processor-based control circuit 510 of the computing device 150 is electrically coupled via a connection 545 to a user interface 550, which may include a visual display or display screen 560 (e.g., LED screen) and/or button input 570 that provide the user interface 550 with the ability to permit an operator of the computing device 150 to manually control the computing device 150 by inputting commands via touch-screen and/or button operation and/or voice commands to, for example, to transmit a control signal to the UAV 110 in order to provide the UAV 110 with the flight route 185 from the UAV deployment location 175 to the delivery destination 180, or to transmit a guiding signal to the UAV 110 to guide the UAV 110 from the delivery destination 180 back toward the UAV deployment location 175 and into a receptacle 154 of the trailer housing 120. It will be appreciated that the performance of such functions by the processor-based control circuit 510 of the computing device 150 is not dependent on a human operator, and that the control circuit 510 may be programmed to perform such functions without a human operator.

In some aspects, the display screen 560 of the computing device 150 is configured to display various graphical interface-based menus, options, and/or alerts that may be transmitted to the computing device 150 and displayed on the display screen 560 in connection with various aspects of the delivery of the products 190 ordered by the customers by the UAVs 110 and various aspects of deploying the UAVs 110 from the trailer housing 120 and/or monitoring the UAVs 110 while they are in-flight toward/away from the delivery destination 180. The inputs 570 of the computing device 150 may be configured to permit an operator to navigate through the on-screen menus on the computing device 150 and make changes and/or updates to the delivery destination 180 and/or the delivery route of the UAVs 110. It will be appreciated that the display screen 560 may be configured as both a display screen and an input 570 (e.g., a touch-screen that permits an operator to press on the display screen 560 to enter text and/or execute commands.)

In some embodiments, after an order for one or more products 190 is placed by a customer via the order processing server 170, and prior to commencement of the delivery attempt of one or more products 190 via the UAV 110 to the delivery destination 180 designated by the customer, the control circuit 510 of the computing device 150 is programmed to obtain the GPS coordinates of the delivery destination 180 where the product 190 is to be delivered by a UAV 110. For example, in embodiments, where the customer requested delivery of a product 190 or products 190 to a delivery destination 180 associated with a specific geographic location (e.g., home address, work address, etc.), the control circuit 510 of the computing device 150 obtains the GPS coordinates associated with the delivery destination 180, for example, from the customer information database 140, or from another source configured to provide GPS coordinates associated with a given physical address.

In some embodiments, the control circuit 510 of the computing device 150 is configured to analyze the GPS coordinates of the initial location of the UAV trailer 120 and delivery vehicle 130, as well as the delivery destination 180, and to determine a UAV deployment location 175 optimal for deploying one or more UAVs 110 from the trailer housing 120 to deliver one or more products 190 to one or more delivery destinations 180, and to generate a route for the delivery vehicle 130 from its initial location to the UAV deployment location 175. In one aspect, for example, when the UAV trailer 120 is loaded with eight UAVs 110 as shown in FIG. 1, based on the known GPS coordinates of each of the delivery destinations 180 intended for the UAVs 110, the control circuit 510 of the computing device can calculate a UAV deployment location that is most central to the eight intended delivery destinations 180. In some embodiments, after the control circuit 510 of the computing device 150 determines and generates driving directions for the delivery vehicle 130, the computing device 150 transmits, via the output 540 and over the network 115, a signal including the flight route 185 to an electronic device of the driver of the delivery vehicle 130 to provide the delivery driver guidance to the UAV deployment location 175.

In some embodiments, the control circuit 510 of the computing device 150 is configured to analyze the GPS coordinates of both the UAV deployment location 175 (where the UAV 110 will be deployed from the trailer housing 120) and the delivery destination 180, and to determine and generate a flight route 185 for the UAV 110. In one aspect, the flight route 185 determined by the computing device 150 is based on a starting location of the UAV 110 (e.g., a UAV deployment location 175) and the intended destination of the UAV 110 (e.g., delivery destination 180 and/or product pick up destination). In some embodiments, after the control circuit 510 of the computing device 150 determines and generates a flight route 185 for the UAV 110, the computing device 150 transmits, via the output 540 and over the network 115, a signal including the flight route 185 to the UAV 110 assigned to deliver one or more products 190 from the UAV deployment location 175 to the delivery destination 180.

In some embodiments, the computing device 150 is capable of integrating 2D and 3D maps of the navigable space of the UAV 110 along the flight route 185 determined by the computing device 150, complete with topography data comprising: no fly zones along the flight route 185 and on-ground buildings, hills, bodies of water, power lines, roads, vehicles, people, and/or known safe landing points for the UAV 110 along the flight route 185. After the computing device 150 maps all in-air and on-ground objects along the flight route 185 of the UAV 110 to specific locations using algorithms, measurements, and GPS geo-location, for example, grids may be applied sectioning off the maps into access ways and blocked sections, enabling the UAV 110 to use such grids for navigation and recognition. The grids may be applied to 2D horizontal maps along with 3D models. Such grids may start at a higher unit level and then can be broken down into smaller units of measure by the computing device 150 when needed to provide more accuracy.

In some embodiments, the computing device 150 is configured for two-way communication with the UAV product loader 134, which allows the computing device 150 to control the UAV product loader 134. For example, in some aspects, the control circuit 510 of the computing device 150 is configured to transmit an activation signal to the UAV product loader 134 and the UAV product loader 134, in response to receipt of the activation signal, is configured to pick one or more of the products 190 identified in the activation signal received from the computing device 150 from the product storage area, and to load the picked products 190 into the UAVs 110 retained in the receptacles 124.

In some embodiments, the UAV product loader 134 is configured to scan identifying indicia located on the packages (or products 190) stored in the cargo area 132 of the delivery vehicle 130. The identifying indicia on the package or product 190 that may be scanned by the sensors 114 may include, but is not limited to: two dimensional barcode, RFID, near field communication (NFC) identifiers, ultra-wideband (UWB) identifiers, Bluetooth identifiers, images, or other such optically readable, radio frequency detectable or other such code, or combination of such codes. To that end, the UAV product loader 134 may include sensors including but not limited to: a photo sensor, a radio frequency identification (RFID) sensor, an optical sensor, a barcode sensor, a digital camera sensor, a size sensor, or the like. It will be appreciated that the product loader 134 may be configured to load products into the UAVs 110 while the UAVs 110 are located in the receptacles 124 and/or while the UAVs 110 are outside of the receptacles 124 and either within the interior space 122 of the trailer 120, or outside of the interior space 122 of the trailer.

In some embodiments, the computing device 150 is configured to receive a signal indicating that one or more products 190 have been loaded into one or more of the UAVs 110 retained in the plurality of the receptacles 124. For example, as mentioned above, each receptacle may include a sensor configured to detect the presence of a UAV 110 in the receptacle 124 and to transmit this information to the computing device 150, such that the computing device 150 is able to recognize which receptacles 124 have UAVs 110 therein and which do not. After receipt of such a signal, the control circuit 510 of the computing device 150 is programmed to transmit a first deployment signal to one or more connectors 126 of one or more receptacles 124 configured to cause one or more receptacles 124 retaining one or more of the UAVs 110 loaded with the products 190 to move from the stowed position to the deployed position. To that end, as mentioned above, in some aspects, the movable connectors 126 of the receptacles 124 may be in the form of remote-controlled motorized swivels that would move in response to receiving a deployment signal from the computing device 150.

In some embodiments, and as mentioned above, the computing device 150 is configured for two-way communication with the movable connectors 126, which are configured to move the receptacles 124 of the trailer housing 120. In some embodiments, each receptacle 124 has a sensor coupled thereto that detects whether the receptacle 124 is in the stowed position or deployed position. This sensor is programmed to transmit a signal to the computing device 150 to indicate whether the receptacle 124 is in a stowed or deployed position. In some aspects, the control circuit 510 of the computing device 150 is configured to transmit an activation signal to a given movable connector 126, which, in response to receipt of the activation signal, is configured to move the receptacle 124 associated with that movable connector 126 from the stowed position as shown in FIG. 2 to the deployed position as shown in FIG. 3. Similarly, in some aspects, the computing device 150 is configured to receive a signal from a sensor/transceiver of the movable connector 126 indicating whether the receptacle 124 is in the stowed or deployed position. In some embodiments, after the products 190 are loaded into the UAVs 110 retained in the receptacles 124 and after the computing device 150 receives a signal indicating that the receptacle 124 containing the product-loaded UAV 110 is now in the deployed position, the control circuit 510 of the computing device 150 is configured to transmit a second deployment signal to such UAVs 110 to cause the UAVs 110 that receive the second deployment signal to lift off from their respective receptacles 124 and to fly toward their respective delivery destinations 180.

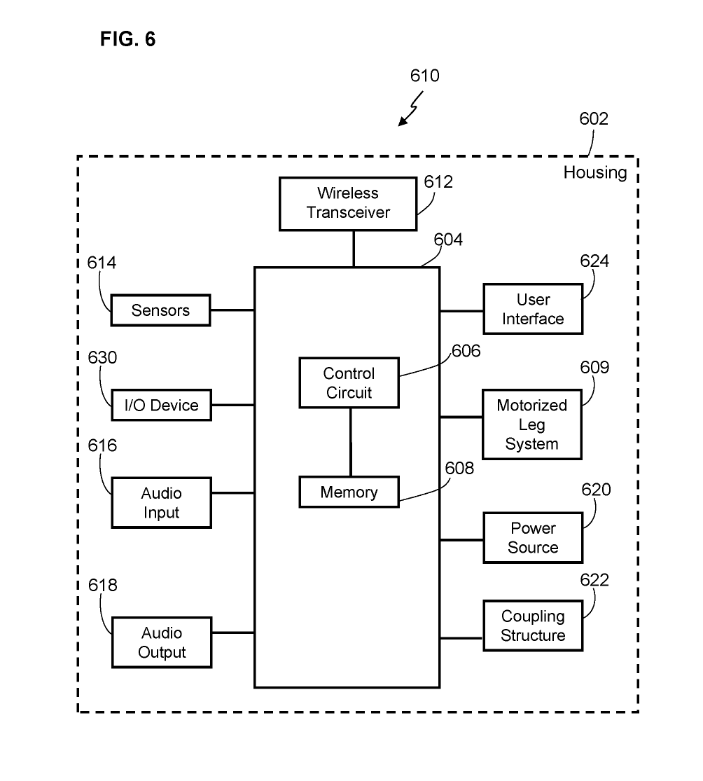

FIG. 6 presents a more detailed exemplary embodiment of the UAV 610 of FIG. 1. In this example, the UAV 610 has a housing 602 that contains (partially or fully) or at least supports and carries a number of components. These components include a control unit 604 comprising a control circuit 606 that, like the control circuit 510 of the computing device 150, controls the general operations of the UAV 610. The control unit 604 includes a memory 608 coupled to the control circuit 606 for storing data such as operating instructions and/or useful data.

In some embodiments, the control circuit 606 operably couples to a motorized leg system 609. This motorized leg system 609 functions as a locomotion system to permit the UAV 610 to land onto the ground or onto a landing pad at the delivery destination 180 and/or to move laterally at the delivery destination 180. Various examples of motorized leg systems are known in the art. Further elaboration in these regards is not provided here for the sake of brevity save to note that the control circuit 606 may be configured to control the various operating states of the motorized leg system 609 to thereby control when and how the motorized leg system 609 operates.

In some aspects, the motorized leg system 609 of the UAV 610 includes multiple support legs. In one aspect, such support legs may provide balance and stability to the UAV 610 after the UAV 610 lands onto a support surface (e.g., receptacle 124, landing pad, top of the delivery vehicle 130, etc.). In certain implementations, the UAV 610 is configured to have support legs that are mechanically (e.g., telescopically) retractable into the interior of the UAV 610 foldable into direct contact/close proximity to the body of the UAV 610 such that the UAV 610 can occupy less space in the receptacle 124 than if the support legs were not retractable. In one aspect, the UAV 610 may be configured such that the rotor blades of the UAV 610 are hinged and do not straighten until they are spinning as a result of centrifugal force.

In the exemplary embodiment of FIG. 6, the control circuit 606 operably couples to at least one wireless transceiver 612 that is configured as a two-way transceiver and operates according to any known wireless protocol. This wireless transceiver 612 can comprise, for example, a cellular-compatible, Wi-Fi-compatible, and/or Bluetooth-compatible transceiver that can wirelessly communicate with the computing device 150 via the network 115. These teachings will accommodate using any of a wide variety of wireless technologies as desired and/or as may be appropriate in a given application setting. These teachings will also accommodate employing two or more wireless transceivers 612. So configured, the control circuit 606 of the UAV 610 can provide information (e.g., sensor input) to the computing device 150 (via the network 115) and can receive information and/or movement (e.g., routing and rerouting) instructions from the computing device 150.

In some embodiments, the wireless transceiver 612 is configured to receive a signal containing instructions including the flight route 185 transmitted from the computing device 150, and that can transmit one or more signals (e.g., including sensor input information detected by one or more sensors of the UAV 110) to the computing device 150. For example, the control circuit 606 of the UAV 610 can receive control signals from the computing device 150 via the network 115 containing instructions regarding directional movement of the UAV 610 along a specific, computing device-determined flight route 185 when, for example: being deployed from the receptacle 124 of the trailer housing 120, flying from the UAV deployment location 175 to the delivery destination 180 to drop off and/or pick up a product 190, and/or when returning from the delivery destination 180 to the UAV deployment location 175.

In particular, as discussed above, the computing device 150 can be configured to analyze GPS coordinates of the delivery destination 180 designated by the customer, determine a flight route 185 for the UAV 110 from the UAV deployment location 175 to the delivery destination 180, and transmit to the wireless transceiver 612 of the UAV 110 a first control signal including the flight route 185 over the network 115. The UAV 110, after receipt of the first control signal and/or guiding signal from the computing device 150 over the network 115 via the wireless transceiver 612, is configured to navigate, based on the route instructions in the control signal and/or guiding signal, to the delivery destination 180 after being deployed from the receptacle 124 of the trailer housing 120. In certain aspects, the computing device 150 can be configured to analyze GPS coordinates of the delivery vehicle 130 and of the trailer housing 120 coupled to the delivery vehicle, and to transmit to the wireless transceiver 612 of the UAV 110 a control signal containing instructions to guide the UAV 610 from its storage receptacle 124 to the delivery vehicle 130, for example, for the purpose of landing on top of the delivery vehicle 130 as shown in FIG. 1 to be loaded with a product 190 by the product loader 134 of the delivery vehicle 130.

With reference to FIG. 6, the control circuit 606 of the UAV 610 also couples to one or more sensors 614 of the UAV 610. These teachings will accommodate a wide variety of sensor technologies and form factors. In some embodiments, the sensors 614 can comprise any relevant device that detects and/or transmits at least one status of the UAV 610 during flight of the UAV 110 along the flight route 185. The sensors 614 of the UAV 610 can include but are not limited to: altimeter, velocimeter, thermometer, GPS data, photocell, battery life sensor, video camera, radar, lidar, laser range finder, sonar, electronics status, and communication status. In some embodiments, the information obtained by the sensors 614 of the UAV 610 is used by the UAV 610 and/or the computing device 150 in functions including but not limited to: navigation, take-offs, landing, on-the-ground object detection, potential in-air object detection, distance measurements, and topography mapping. In some aspects, the status input detected and/or transmitted by one or more sensors 614 of the UAV 610 includes but is not limited to GPS coordinates of the UAV 610, marker beacon data along the flight route 185, and way point data along the flight route 185.

For example, in some aspects, the sensors 614 include one or more devices that can be used to capture data related to one or more in-air objects (e.g., other UAVs 610, helicopters, birds, rocks, etc.) located within a threshold distance relative to the UAV 610. For example, the UAV 610 includes at least one sensor 614 configured to detect at least one obstacle between the UAV 610 and the delivery destination 180 designated by the customer. Based on the detection of one or more obstacles by such a sensor 614, the UAV 610 is configured to avoid the obstacle(s). In some aspects, the UAV 610 may attempt to avoid detected obstacles, and if unable to avoid, to notify the computing device 150 of such a condition. In some aspects, using sensors 614 (such as distance measurement units, e.g., laser or other optical-based distance measurement sensors), the UAV 610 detects obstacles in its path, and flies around such obstacles or stops until the obstacle is clear.

In some aspects, the UAV 610 includes sensors 614 configured to recognize environmental elements along the flight route 185 of the UAV 610 toward and/or away from the delivery destination 180. Such sensors 614 can provide information that the control circuit 606 and/or the computing device 150 can employ to determine a present location, distance, and/or orientation of the UAV 610 relative to one or more in-air objects and/or objects and surfaces at the delivery destination 180 and/or the UAV deployment location 175 (e.g., landing surface of the receptacle 124, landing surface(s) on/in the delivery vehicle 130, etc.). These teachings will accommodate any of a variety of distance measurement units including optical units and sound/ultrasound units. A sensor 614 may comprise an altimeter and/or a laser distance sensor device capable of determining a distance to objects in proximity to the sensor 614.

In some aspects, the UAV 610 includes an sensor 614 (e.g., a video camera) configured to detect map reference and/or topography and/or people and/or objects at the delivery destination 180 and/or UAV deployment location 175. For example, in some aspects, a video camera-based sensor 614 of the UAV 610 transmits images during the attempted take-off/landing of the UAV 610 from/into the receptacle 124, facilitating the correct position and/or orientation of the UAV 610 when landing into a receptacle 124 and/or when lifting from the receptacle 124. In some embodiments, the UAV 610 may comprise one or more sensors 614 including but not limited to: an optical sensor, a camera, an RFID scanner, a short range radio frequency transceiver, etc., which are configured to detect and/or identify a receptacle 124 based on guidance systems and/or identifiers (e.g., one or more lights, lasers, etc.) of the receptacle 124.

For example, as discussed above, the UAV 610 may land onto a receptacle such that one or more landing sensors 614 of the UAV 610 are aligned with one or more guidance lights/lasers of the receptacle 124. In some embodiments, the UAV 610 includes one or more sensors 614 configured to capture identifying information of a receptacle 124 based on a visual identifier of the receptacle 124 (e.g., an optically readable code, a radio frequency identification (RFID) tag, an optical beacon, a radio frequency beacon, or the like). By the same token, in some embodiments, the receptacle 124 includes one or more sensors configured to capture identifying information of a UAV 610 based on a visual identifier of the UAV 610 (e.g., an optically readable code, a radio frequency identification (RFID) tag, an optical beacon, a radio frequency beacon, or the like), which facilitates the validation of the UAV 610 attempting to land into the receptacles 124 of the trailer housing 120 and prevention of rogue/malicious UAVs from landing into the receptacles 124. In some aspects, the sensor 614 of the UAV 610 is configured to transmit (e.g., via internal circuitry and/or via the transceiver 612) still and/or moving images of the landing location (e.g., receptacle 124 of the trailer 120, product drop off spot at the delivery destination 180, etc.) to the control circuit 606 of the UAV 110 and/or the control circuit 210 of the computing device 150, which allows the control circuit 606 of the UAV 610 and/or the control circuit 210 of the computing device 150 to determine the correct position and/or orientation of the UAV 610 required for the proper landing of the UAV 610.

In some embodiments, an audio input 616 (such as a microphone) and/or an audio output 618 (such as a speaker) can also operably couple to the control circuit 606 of the UAV 610. So configured, the control circuit 606 can provide for a variety of audible sounds to enable the UAV 610 to communicate with, for example, the computing device 150, other UAVs, or other in-air or ground-based electronic devices (e.g., electronic device of the driver of the delivery vehicle 130). Such sounds can include any of a variety of tones and/or sirens and/or other non-verbal sounds. Such audible sounds can also include, in lieu of the foregoing or in combination therewith, pre-recorded or synthesized speech.

In the embodiment illustrated in FIG. 6, the UAV 610 includes a power source 620 such as one or more batteries. The power provided by the power source 620 can be made available to whichever components of the UAV 610 require electrical energy. By one approach, the UAV 610 includes a plug or other electrically conductive interface that the control circuit 606 can utilize to permit the UAV 610 to physically connect (e.g., via compatible plugs/adapter, magnetic cables, etc.) and/or remotely couple (via induction signals, etc.) to an external source of energy (located in the receptacle 124 and/or adjacent the receptacle 124, or at the delivery destination 180) in order to recharge and/or replace the power source 620. In some aspects, the power source 620 is configured as a rechargeable battery that can be recharged by a charging source. In other embodiments, the power source 620 is configured as one or more replaceable batteries that can be removed and replaced. In some aspects, the power source 620 may be configured as a device that can be recharged by induction (e.g., RF induction, light induction, laser induction, thermal induction, etc.).

These teachings will also accommodate optionally selectively and temporarily coupling the UAV 610 to one or more structures and/or electronic devices (e.g., receptacle 124, charging source, landing pad, deployment dock, etc.). In such aspects, the UAV 610 includes a coupling structure 622. By one approach such a coupling structure 622 operably couples to a control circuit 606 to thereby permit the latter to control movement of the UAV 610 (e.g., via hovering and/or via the motorized leg system 609) towards a particular receptacle 124 until the coupling structure 622 can engage the receptacle 124 to thereby temporarily physically couple the UAV 610 to the receptacle 124.

The exemplary UAV 610 of FIG. 6 also includes a an input/output (I/O) device 630 that is coupled to the control circuit 606. The I/O device 630 allows an external device to couple to the control unit 604. The function and purpose of connecting devices will depend on the application. In some examples, devices connecting to the I/O device 630 may add functionality to the control unit 604, allow the exporting of data from the control unit 304, allow the diagnosing of the UAV 610, and so on.

The exemplary UAV 610 of FIG. 6 also includes a user interface 624 including, for example, user inputs and/or user outputs or displays depending on the intended interaction with a user (e.g., a worker of a retailer, driver of the delivery vehicle 130, a customer, etc.). For example, user inputs could include any input device such as buttons, knobs, switches, touch sensitive surfaces or display screens, and so on. Example user outputs include lights, display screens, and so on. The user interface 624 may work together with or separate from any user interface implemented at an optional user interface unit (such as a smart phone or tablet device) usable by a worker at a facility of the retailer and/or by the driver of the delivery vehicle 130.

In some embodiments, the UAV 610 may be controlled by a user in direct proximity to the UAV 610, for example, an operator at the UAV deployment location 175 (e.g., a driver of the delivery vehicle 130), or by a user at any location remote to the location of the UAV 610 (e.g., regional or central hub operator). This is due to the architecture of some embodiments where the computing device 150 outputs control signals to the UAV 610. These controls signals can originate at any electronic device in communication with the computing device 150. For example, the signals sent to the UAV 610 may be movement instructions determined by the computing device 150 and/or initially transmitted by a device of a user to the computing device 150 and in turn transmitted from the computing device 150 to the UAV 610.

The control unit 604 of the UAV 610 includes a memory 608 coupled to a control circuit 606 and storing data such as operating instructions and/or other data. The control circuit 606 can comprise a fixed-purpose hard-wired platform or can comprise a partially or wholly programmable platform. These architectural options are well known and understood in the art and require no further description. This control circuit 606 is configured (e.g., by using corresponding programming stored in the memory 608 as will be well understood by those skilled in the art) to carry out one or more of the steps, actions, and/or functions described herein. The memory 608 may be integral to the control circuit 606 or can be physically discrete (in whole or in part) from the control circuit 606 as desired. This memory 608 can also be local with respect to the control circuit 606 (where, for example, both share a common circuit board, chassis, power supply, and/or housing) or can be partially or wholly remote with respect to the control circuit 606. This memory 608 can serve, for example, to non-transitorily store the computer instructions that, when executed by the control circuit 606, cause the control circuit 606 to behave as described herein. It is noted that not all components illustrated in FIG. 6 are included in all embodiments of the UAV 610. That is, some components may be optional depending on the implementation.

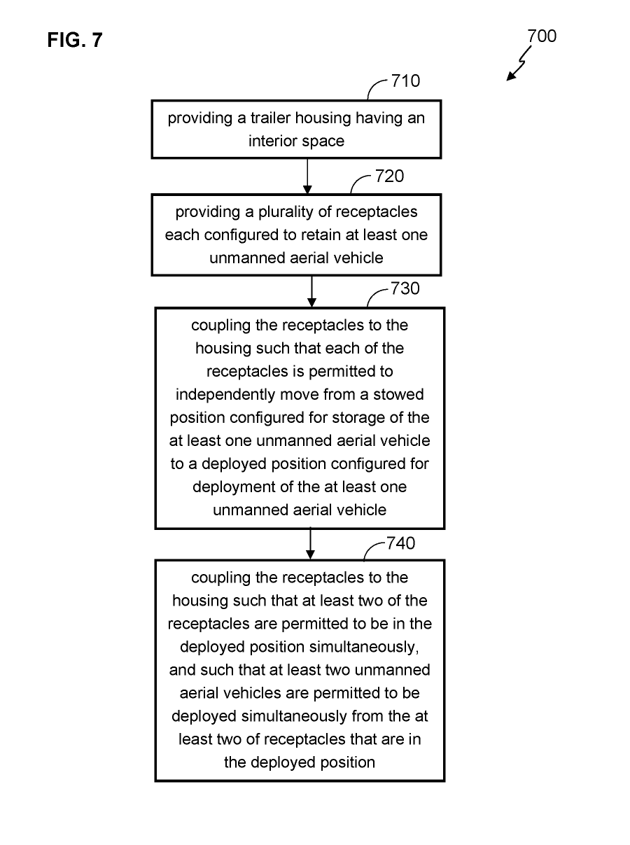

FIG. 7 shows an embodiment of an exemplary method 400 of transporting and deploying unmanned aerial vehicles 110 configured to transport one or more products 190 to customers in one or more delivery destinations 180. For exemplary purposes, the method 700 is described in the context of the system 100 of FIG. 1, but it is understood that embodiments of the method 400 may be implemented in this or other systems.

The embodiment of the method 700 illustrated in FIG. 7 includes providing a trailer housing 120 having an interior space 122 (step 710) and providing a plurality of receptacles 124 each configured to retain at least one UAV 110 (step 720). As discussed in more detail above, the receptacles 124 may be trays, drawers, or combinations or trays and drawers, which are coupled to the trailer housing 120 and/or to each other in a stacked orientation such that the UAVs 110 (other than those in the bottom-most receptacles 124) retained in such receptacles 124 are stacked on top of one or more other UAVs 110. In some aspects, the receptacles 124 include one or more sensors that determine whether the receptacles 124 are in the stowed deployed position and whether a UAV 110 is present in the interior of the receptacle 124 or not. As described above, in some embodiments, the receptacles are movably coupled to the trailer housing 120 via movable connectors 126 which, in some aspects, include wireless transceivers configured to receive an activation signals from the computing device 150 as well as a mechanism (e.g., electric motor, etc.) configured to move the receptacles 124 between the stowed and deployed position in response to the movable connector 126 receiving an activation signal from the computing device 150.

In the illustrated embodiment, the receptacles 124 of the trailer housing 120 are coupled to the trailer housing 120 such that each of the receptacles 124 is permitted to independently move from a stowed position (see FIG. 2) configured for storage of the UAVs 110 to a deployed position (see FIGS. 3-4) configured for deployment of the UAVs 110. To that end, the exemplary method 700 of FIG. 7 includes coupling the receptacles 124 to the trailer housing 120 such that each of the receptacles 124 is permitted to independently move from a stowed position configured for storage of one or more UAVs 110 to a deployed position configured for deployment of one or more UAVs 110 (step 730).

The method 400 further includes coupling the receptacles 124 to the trailer housing 120 such that at least two of the receptacles 124 are permitted to be in the deployed position simultaneously (as shown in FIGS. 3 and 4), and such that at least two UAVs 110 are permitted to be deployed simultaneously from two or more receptacles 124 that are in the deployed position (step 740). In other words, the receptacles 124 are coupled to the trailer housing 120 via movable connectors 126 such that two or more of the receptacles 124 are permitted to be in the deployed position simultaneously, as shown, for example, in FIG. 3.

In particular, as shown in FIGS. 3 and 4, the trailer housing 120 is configured such that when the receptacles 124 are moved to the deployed position, no receptacle 124 that is in the deployed position overlays another receptacle 124 that is in the deployed position. In other words, when a receptacle 124 of the trailer housing 120 is in the deployed position and ready to deploy one or more UAVs 110 therefrom, such a receptacle 124 does not overlay any other deployed receptacles 124 and thus does not obstruct deployment of UAVs 110 from such other deployed receptacles 124. As a result, the trailer housing 120 is configured to permit two or more UAVs 110 to be deployed simultaneously from two or more receptacles 124 when the receptacles 124 are in the deployed position.

In addition, as discussed above, the computing device 150 is configured to obtain and analyze the relative locations of the UAVs 110, receptacles 124 of the trailer housing 120, and/or UAV landing locations (e.g., product loading location) on or in the delivery vehicle 130, in order to generate route instructions for the UAVs 110 that guide the UAVs 110 in taking off from the receptacles 124 and/or landing onto the delivery vehicle 130 for product loading purposes. In some embodiments, as discussed above, the products 190 may be preloaded into one or more of the UAVs 110 prior to the UAVs 110 being loaded into the receptacles 124 of the trailer housing 120, such that the loading of products 190 from the cargo area 132 of the delivery vehicle 130 into the UAV 110 becomes unnecessary. As discussed above, the computing device 150 is configured to obtain and analyze the relative locations of the UAV deployment location 175 and delivery destination 180 in order to determine a flight route 185 for the UAV 110 from the UAV deployment location to the delivery destination 180. For example, in some embodiments, the computing device 150 obtains GPS data associated with the delivery destination 180 from the customer information database 140 and GPS data associated with the UAV deployment location from the central electronic database 160.

In some embodiments, as mentioned above, each receptacle 124 has a sensor coupled thereto that detects whether the receptacle 124 is in the stowed position or deployed position and that is configured to transmit a signal containing this information to the computing device 150. In some aspects, after the trailer housing 120 arrives at the UAV deployment location 175 calculated by the computing device 150, the control circuit 510 of the computing device 150 transmits one or more activation signals to one or more movable connectors 126 associated with the receptacles 124 in order to cause the receptacles 124 to be moved by such movable connector(s) 126 from the stowed position to the deployed position.

In some aspects, after the computing device 150 receives a signal (e.g., from one or more sensors associated with a receptacle 124) indicating that the receptacle 124, which contains a UAV 110 tasked with delivering products 190 to a given delivery destination 180), is in a deployed position, the computing device 150 transmits a deployment signal to one or more UAVs 110 located in such deployed receptacles 124, thereby causing the UAV(s) 110 to lift off from the receptacle and either fly directly to the delivery destination 180 (if the UAV 110 is already loaded with products 190 to be delivered) along the delivery route 185 determined by the computing device 150, or to the delivery vehicle 130 to be loaded with the products 190 to be delivered.

In some embodiments, after the computing device 150 receives a signal (e.g., from the UAV 110 and/or from a UAV-detecting sensor associated with a receptacle 124) indicating that a UAV 110 has been deployed from the receptacle 124, the computing device 150 transmits one or more signals to one or more movable connectors 126 associated with the receptacles 124 in order to cause the receptacles 124 to be moved by such movable connector(s) 126 from the deployed position back to the stowed position. As discussed above, while the UAV 610 is in flight along the flight route 185 from the UAV deployment location 175 to the delivery destination 180, the sensors 614 of the UAV 610 monitor various parameters relating to the flight mission of the UAV 610 and the status of the UAV 610. The sensor inputs detected by the sensors 614 of the UAV 610 are transmitted (e.g., via the wireless transceiver 612) to the computing device 150 and/or central electronic database 160 over the network 115. Such sensor inputs (e.g., GPS sensor) enables the computing device 150 to determine the exact location of the UAV 610 in order to guide the UAV 610 to land into the receptacle 124 upon return from its delivery mission.

In some embodiments, after the computing device 150 receives a signal from the UAV 110 (e.g., GPS data) indicating that a UAV 110 is approaching the trailer housing 120 for landing after a successful product delivery mission, the computing device 150 transmits one or more signals to one or more movable connectors 126 associated with the receptacles 124 in order to cause the receptacles 124 to be moved by such movable connector(s) 126 from the stowed position to the deployed position in order to permit the UAV 110 to land into the receptacle 124. As described above, the UAV 110 may be guided by one or more lights/lasers included in the receptacle 124 to facilitate a precise landing of the UAV 110 into the receptacle 124. In some aspects, after the UAV-detecting sensor of the receptacle 124 transmits a signal to the computing device 150 to confirm that the UAV 110 has landed into the receptacle 124, the computing device 150 transmits one or more signals to one or more movable connectors 126 associated with the receptacles 124 in order to cause the receptacles 124 to be moved by such movable connector(s) 126 from the deployed position back to the stowed position for storing and/or recharging of the UAV 110 prior to deployment of the UAV 110 for its subsequent delivery mission.

The systems and methods described herein advantageously provide for delivering products to consumers via mobile UAV-deploying trailers that may be hauled to a deployment location in geographic proximity to one or more delivery destinations, after which multiple UAVs may be deployed simultaneously from the trailers to deliver multiple products to multiple customers. Such systems and methods advantageously provide retailers with significant operation efficiency and cost savings.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A trailer system for transporting and deploying unmanned aerial vehicles configured to transport one or more products to customers in one or more delivery destinations, the system comprising:
a trailer housing having an interior space;
a plurality of receptacles each configured to retain at least one unmanned aerial vehicle;
wherein the receptacles are coupled to the housing such that each of the receptacles is permitted to independently move from a stowed position configured for storage of the at least one unmanned aerial vehicle to a deployed position configured for deployment of the at least one unmanned aerial vehicle; and
wherein the receptacles are coupled to the housing such that at least two of the receptacles are permitted to be in the deployed position simultaneously, and such that at least two unmanned aerial vehicles are permitted to be deployed simultaneously from the at least two of receptacles that are in the deployed position.

2. The system of claim 1, wherein the housing comprises a mesh material configured to permit ambient air to flow into the interior space of the housing through openings in the mesh material.

3. The system of claim 1, wherein each of the receptacles is one of a tray and a drawer configured to retain a plurality of unmanned aerial vehicles such that at least one of the unmanned aerial vehicles is stacked on top of at least one other of the unmanned aerial vehicles.

4. The system of claim 1, wherein no receptacle that is in the deployed position overlays another receptacle that is in the deployed position.

5. The system of claim 1, further comprising a plurality of unmanned aerial vehicles retained in the plurality of the receptacles, each unmanned aerial vehicle including a body, a processor-based control circuit coupled to the body, an interior cavity configured to retain at least one of the products, and at least one landing sensor, and wherein each of the receptacles includes at least one laser coupled thereto that permits an unmanned aerial vehicle that is returning to the trailer from the delivery destination to align with the laser via the at least one landing sensor for landing onto the receptacle in alignment with the laser.

6. The system of claim 5, wherein each of the unmanned aerial vehicle further comprises a plurality of support legs extending from the body, and wherein the support legs are configured to be retractable into the body during or after the landing of the unmanned aerial vehicle onto the receptacle.

7. The system of claim 5, further comprising:
a product storage area within the interior space of the trailer housing, the product storage area configured to store one or more of the products before the one or more products are loaded into the unmanned aerial vehicles retained in the plurality of the receptacles; and
a product loading device configured to pick one or more of the products from the product storage area and to load the one or more of the products picked from the product storage area into the unmanned aerial vehicles retained in the plurality of the receptacles.

8. The system of claim 7, further comprising a computing device including control unit having a programmable processor, the computing device being communicatively coupled to the product loading device, the computing device being configured to transmit an activation signal to the product loading device, the product loading device being configured, in response to receipt of the activation signal, to pick one or more of the products from the product storage area and to load the one or more of the products picked from the product storage area into the unmanned aerial vehicles retained in the plurality of the receptacles.

9. The system of claim 8, wherein the computing device is programmed to:
receive a signal indicating that the one or more products have been loaded into one or more of the unmanned aerial vehicles retained in the plurality of the receptacles;
transmit a first deployment signal configured to cause one or more receptacles retaining one or more unmanned aerial vehicles loaded with the one or more products to move from the stowed position to the deployed position; and
transmit a second deployment signal to the control circuit of the one or more unmanned aerial vehicles loaded with the one or more products and retained in one or more receptacles that are in the deployed position in order to cause the one or more unmanned aerial vehicles that receive the second deployment signal to lift off from their respective receptacles and to fly toward their respective delivery destinations.

10. The system of claim 1, wherein the housing is configured to expand in at least one of a direction along a length of the housing and a direction along a width of the housing in order to increase a volume of the interior space of the housing.

11. A method for transporting and deploying unmanned aerial vehicles configured to transport one or more products to customers in one or more delivery destinations, the method comprising:
providing a trailer housing having an interior space;
providing a plurality of receptacles each configured to retain at least one unmanned aerial vehicle;
coupling the receptacles to the housing such that each of the receptacles is permitted to independently move from a stowed position configured for storage of the at least one unmanned aerial vehicle to a deployed position configured for deployment of the at least one unmanned aerial vehicle; and
coupling the receptacles to the housing such that at least two of the receptacles are permitted to be in the deployed position simultaneously, and such that at least two unmanned aerial vehicles are permitted to be deployed simultaneously from the at least two of receptacles that are in the deployed position.

12. The method of claim 11, wherein the providing the trailer housing step further comprises providing the trailer housing with a mesh material configured to permit ambient air to flow into the interior space of the housing through openings in the mesh material.

13. The method of claim 11, wherein each of the receptacles is one of a tray and a drawer, and further comprising retaining a plurality of unmanned aerial vehicles in each of the receptacles such at least one of the unmanned aerial vehicles is stacked on top of at least one other of the unmanned aerial vehicles.

14. The method of claim 11, further comprising deploying at least two of the receptacles such that no receptacle that is in the deployed position overlays another receptacle that is in the deployed position.

15. The method of claim 11, further comprising:
providing a plurality of unmanned aerial vehicles retained in the plurality of the receptacles, each unmanned aerial vehicle including a body, a processor-based control circuit coupled to the body, an interior cavity configured to retain at least one of the products, and at least one landing sensor; and
providing each of the receptacles with at least one laser coupled thereto that permits an unmanned aerial vehicle that is returning to the trailer from the delivery destination to align with the laser via the at least one landing sensor for landing onto the receptacle in alignment with the laser.

16. The method of claim 15, further comprising providing each of the unmanned aerial vehicles with a plurality of support legs extending from the body, the support legs being configured to be retractable into the body during or after the landing of the unmanned aerial vehicle onto the receptacle.

17. The method of claim 15, further comprising:
providing a product storage area within the interior space of the trailer housing, the product storage area configured to store one or more of the products before the one or more products are loaded into the unmanned aerial vehicles retained in the plurality of the receptacles; and
providing a product loading device configured to pick one or more of the products from the product storage area and to load the one or more of the products picked from the product storage area into the unmanned aerial vehicles retained in the plurality of the receptacles.

18. The method of claim 17, further comprising:
providing a computing device including a control unit having a programmable processor, the computing device being communicatively coupled to the product loading device;
transmitting, from the computing device, an activation signal to the product loading device;
by the product loading device and in response to receipt of the activation signal, picking one or more of the products from the product storage area and loading the one or more of the products picked from the product storage area into the unmanned aerial vehicles retained in the plurality of the receptacles.

19. The method of claim 18, further comprising:
receiving, via the computing device, a signal indicating that the one or more products have been loaded into one or more of the unmanned aerial vehicles retained in the plurality of the receptacles;
transmitting, via the computing device, a first deployment signal configured to cause one or more receptacles retaining one or more unmanned aerial vehicles loaded with the one or more products to move from the stowed position to the deployed position; and
transmitting, via the computing device, a second deployment signal to the control circuit of the one or more unmanned aerial vehicles loaded with the one or more products and retained in one or more receptacles that are in the deployed position in order to cause the one or more unmanned aerial vehicles that receive the second deployment signal to lift off from their respective receptacles and to fly toward their respective delivery destinations.

20. The method of claim 11, wherein the providing the trailer housing step further comprises providing the housing configured to expand in at least one of a direction along a length of the housing and a direction along a width of the housing in order to increase a volume of the interior space of the housing.
